(19) United States
(12) Patent Application Publication
(10) Pub. No.: US 2026/0147149 A1
(43) Pub. Date: May 28, 2026

(54) Arrangement of an Illumination Device on a Laminated Glass Pane for a Vehicle, Vehicle and Laminated Glass Pane for a Vehicle

(71) Applicant: Mercedes-Benz Group AG, Stuttgart (DE)

(72) Inventor: Achim DEMMER, Magstadt (DE)

(21) Appl. No.: 19/121,321

(22) PCT Filed: Oct. 16, 2023
(86) PCT No.: PCT/EP2023/078618

§ 371 Date: Apr. 15, 2025

(30) Foreign Application Priority Data
Oct. 17, 2022 (DE) 10 2022 003 821.8

(51) Int. Cl. F21V 8/00; B32B 3/26; B32B 7/12; B32B 17/10; B60J 1/00; B60Q 3/208

(52) U.S. Cl. CPC G02B 6/0068; B32B 3/266; B32B 7/12; B32B 17/10036; B32B 17/10541; B60J 1/001; B60Q 3/208; B32B 2255/26; B32B 2605/00

(57) ABSTRACT

An arrangement of a vehicle includes an illumination device and a laminated glass pane where the illumination device is disposed on the laminated glass pane and where the laminated glass pane has a first pane, a second pane, and a film disposed between the first pane and the second pane. The illumination device has a light source that is disposed at least partially in a cavity of the second pane. The light source is connected to a support element where the light source is supplyable with electrical energy via the support element. The second pane has a coating that covers the cavity, the light source, and the support element on a first side of the second pane that faces away from the first pane and from the film and that faces towards an interior of the vehicle.

### BACKGROUND AND SUMMARY OF THE INVENTION

The invention relates to an arrangement of an illumination device on a laminated glass pane for a vehicle. Furthermore, the invention relates to a vehicle, in particular a motor vehicle, and to a laminated glass pane.

EP 0 997 333 B1 discloses a transparent roof module for a vehicle roof, having a transparent pane, designed as a clear glass pane, in which at least and only one part of the surface of the pane, which due to its design cannot be used for looking through from the inside of the vehicle to the outside, is provided with solar cells.

The object of the present invention is to create an arrangement of an illumination device on a laminated glass pane for a vehicle, a vehicle having such an arrangement and a laminated glass pane for a vehicle, so that a particularly high level of robustness, in particular against glass breakage, can be realized.

The invention relates to an arrangement of an illumination device on a laminated glass pane for a vehicle, in particular for a motor vehicle. The laminated glass pane has two panes which are arranged in at least partial mutual overlap. Thus, at least respective partial regions of the panes mutually overlap. In particular, the panes, preferably designed as glass panes, at least predominantly, in particular completely, mutually overlap. The laminated glass pane also has a film which is arranged between the panes and therefore in particular between the mutually overlapping partial regions of the panes. In particular, the film is formed from a plastic and thus designed as a plastic film. For example, the plastic, from which the film is formed, may be PVB (polyvinyl butyral), so that the film is preferably designed as a PVB film. The panes and the film and thus the laminated glass pane are translucent and are used, for example, as a or for a roof element of a roof of the vehicle, so that the interior of the vehicle is delimited in the vehicle vertical direction upwards at least partially by the laminated glass pane. In this case, it is conceivable that the roof element is designed separately from the body of the vehicle, delimiting the interior, and is connected to the body. As the film and the panes are translucent, for example, light, such as sunlight in particular, can pass through the laminated glass pane from the surroundings of the vehicle and, in particular when the interior is not shaded, penetrate the interior. Thus, the roof or the roof element may in particular be a glass roof.

In the arrangement, the illumination device has at least one light source, which can be operated electrically, for example. The light source can provide, i.e., radiate, light, in particular by electrical operation of the light source. The light source is at least partially, in particular at least predominantly or completely, arranged in a corresponding cavity of one of the panes. If the light source provides light, the light provided by the light source can be supplied i.e., coupled, into one pane and via that one pane into the laminated glass pane, so that, for example, a particularly advantageous illumination of the laminated glass pane and the interior can be realized. For example, the light source is designed as a light-emitting diode (LED).

In order to be able to realize a particularly high level of robustness of the laminated glass pane in particular against breaking, i.e., in order to be able to keep breakage sensitivity of the laminated glass pane particularly low, it is provided according to the invention that the one pane having the cavity is provided, in particular only, on its side, also referred to as an inner side and facing away from the other pane and from the film and facing towards the interior of the vehicle, with at least one coating, covering the cavity and the light source, in particular in each case completely, which coating directly touches the inner side, for example. It has been shown that the cavity, also referred to as a hole or opening, which, for example, is moulded in one pane and/or drilled into one pane, weakens this pane in such a way that its mechanical stability is reduced. Furthermore, the cavity can lead to increased interior stresses in the one pane. It is conceivable that the illumination device has at least one further or several further light sources, wherein the preceding and following embodiments for the first light source can be easily transferred to the respective, further light source and vice versa. Thus, it is conceivable that the respective, further light source is arranged at least partially in a respective further cavity of the one pane, wherein the following and preceding embodiments for the first cavity can be easily transferred to the respective, further cavity and vice versa. The more light sources and corresponding cavities there are in one pane, the more this pane, designed in particular as a glass pane, is weakened. In other words, the breakage sensitivity of the one pane increases with the number of cavities. In the invention, the one pane is now reinforced by means of the coating, whereby an advantageously high level of robustness of the one pane in particular against breakages can be achieved. If the one pane has several cavities in which respective light sources are arranged, it is conceivable that the one pane is provided locally, on its side facing away from the other pane and from the film, with a respective coating covering the respective cavity and the respective light source, in particular in each case completely, wherein it is conceivable that the coatings are spaced apart and thus separated from one another.

However, it has been shown to be particularly advantageous when the coatings are connected to each other, in particular two-dimensionally, whereby the coatings form an in particular continuous overall coating. In other words, it has been shown as advantageous when the one pane is provided on its side, facing away from the other pane and the film, with a coating which covers the cavities and the light sources, in particular in each case completely, and thus, for example, is the aforementioned overall coating. As a result, the one pane can be particularly advantageously reinforced.

For example, the mentioned side of the one pane faces towards the interior and is thus an inner side of the one pane, facing towards the interior, which is thus arranged on an inner side of the other pane, facing towards the interior, and thus is designed as an internal pane, i.e., as an inner pane. Consequently, for example, the other pane is arranged on an outer side of the one pane, facing away from the interior, so that the other pane is an external pane, i.e., an outer pane, for example.

In order to be able to reinforce the one pane particularly advantageously by means of the coating, so that a particularly high level of robustness can be achieved, it is provided in one embodiment that the coating is formed from a plastic.

In this case, it has shown to be particularly advantageous when the plastic from which the coating is formed is an ethylene vinyl acetate (EVA). This means that a particularly high level of robustness can be realized.

It is conceivable that the coating is designed as a plastic film which is provided in particular in addition to the film and is formed preferably from EVA and thus is designed as a tear-resistant EVA film. In particular, the plastic film may be a splinter protection film which more preferably can be formed from the mentioned EVA. For example, the plastic film is locally, i.e., spatially, laminated on the one pane, i.e., on the side of the one pane, whereby the one pane can be reinforced particularly well.

The feature that the one pane is provided, in particular exclusively, locally, i.e., spatially, with the at least one coating on its side facing away from the other pane and from the film, is to be understood as meaning that the coating is arranged, in particular exclusively, in at least or exactly one first partial region of the one pane, wherein the one pane has at least or exactly one second partial region, in particular directly adjoining the first partial region, which is free from the coating. In other words, the one pane has on the mentioned side a surface which in particular is facing towards the interior of the vehicle. The aforementioned, first partial region of the one pane is a first partial region of the surface, so that the coating is arranged in the first partial region of the surface. The aforementioned, second partial region of the one pane is a second partial region of the surface, wherein the second partial region adjoins, in particular directly, the first partial region. The surface of the one pane is free from the coating in the second partial region. Thus, the surface or the one pane is provided only locally on the mentioned side with the coating. Therefore, an effective and weight-optimized and cost-effective reinforcement of the one pane can be realized.

A further embodiment is characterized in that the coating is formed from a plastic foam. This means that a particularly high level of robustness can be realized.

In order to be able to reinforce the one pane particularly effectively by means of the plastic foam, it is provided in a further embodiment of the invention that the plastic foam is a polyurethane foam, i.e., a PU foam.

A further embodiment provides that the cavity is designed as a blind hole. Therefore, excessive weakening of the one pane can be avoided. The blind hole is understood to mean an opening which does not completely penetrate the one pane but is delimited completely towards the film and towards the other pane by a wall portion of the one pane. On the mentioned side of the one pane, the blind hole itself is open, so that, for example, during production of the arrangement, the light source can be moved, from the side of the one pane into the blind hole, in particular inserted therein.

According to the invention, it is furthermore provided that the light source is connected to a support element, also referred to as a light element support, via which the light source can be supplied with electrical energy, whereby the light source can provide the mentioned light. In particular, the support element is or has a circuit board, for example, via which the light source can be supplied with the electrical energy. In order to be able to realize a particularly high level of robustness, it is provided that, in addition to covering the cavity and the light source that projects at least partially into the cavity or is alternatively arranged completely therein, the coating covers and thus overlaps, in particular completely, the support element, in particular with respect to the interior. Thus, for example, the coating touches both the support element, in particular a surface of the support element facing away from the one pane, and the one pane, whereby the one pane can be advantageously reinforced.

Lastly, it has been shown to be particularly advantageous when the light source is connected to the one pane by adhesion. Preferably, it is provided that the light source is glued into the cavity. This is understood in particular to mean that the light source is adhesively bonded to the one pane inside the cavity. Again, expressed in other words, an adhesive is arranged in the cavity, by means of which the light source is adhesively bonded to the one pane. Therefore, weakening of the one pane caused by the cavity itself can be advantageously counteracted, so that a particularly high level of robustness can be achieved.

A vehicle, preferably designed as a motor vehicle, in particular as an automobile, is also included in the invention, which vehicle has an arrangement according to the invention. Advantages and advantageous embodiments of the arrangement according to the invention are considered as advantages and advantageous embodiments of the vehicle according to the invention and vice versa. The same applies for the laminated glass pane.

In this case, it has been shown as particularly advantageous when the coating is arranged outside a viewing area of the laminated glass pane, also referred to as a see-through area or glass viewing area. The viewing area of the laminated glass pane is a region through which people in the interior of the vehicle can look and thus see the surroundings of the vehicle. Since it is now preferably provided that the coating is arranged, in particular completely, outside the viewing area, a person in the interior of the vehicle cannot see the coating or the viewing area is not undesirably reduced or otherwise negatively impaired by the coating.

Further advantages and details of the invention result from the following description and using the drawings.

### BRIEF DESCRIPTION OF THE DRAWINGS

FIG. 1 shows in part a schematic and sectional side view of an arrangement of an illumination device on a laminated glass pane for a vehicle; and

FIG. 2 shows a schematic plan view of the arrangement.

### DETAILED DESCRIPTION OF THE DRAWINGS

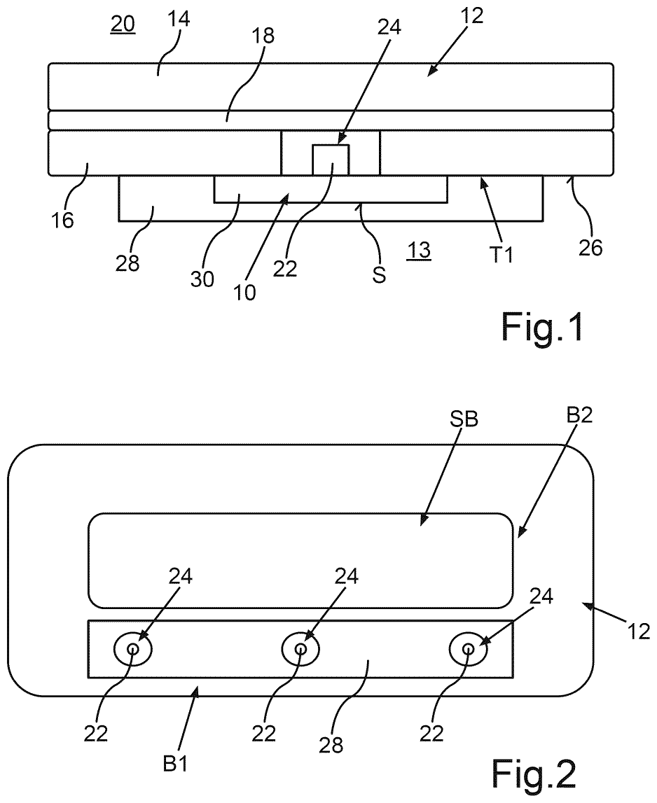

FIG. 1 shows in part, in a schematic and sectional side view, an arrangement of an illumination device 10 on a laminated glass pane 12 of a vehicle, wherein the interior of the vehicle is marked with 13 in FIG. 1. The interior 13 is formed by a body, preferably designed as a self-supporting body, of the vehicle, which is designed preferably as an automobile, in particular as a passenger car.

The laminated glass pane 12 is, for example, a component of a roof element, also referred to as a glass roof, which is designed separately from the body and is connected to the body. The laminated glass pane 12 has a first pane 14, designed as a first glass pane, and a second pane 16, designed as a second glass pane, which mutually overlap at least in respective overlapping regions. The laminated glass pane 12 further comprises a film 18, preferably designed as a plastic film, which is arranged between the panes 14 and 16, in particular between the overlapping regions, so that the panes 14 and 16 and the film 18 mutually overlap at least in respective overlapping regions. The panes 14 and 16, designed as glass panes, and the film are translucent, so that light, such as sunlight, for example, from the surroundings 20 of the vehicle can pass through the panes 14 and 16 and the film 18 and, particularly when the interior 13 is not shaded, can penetrate, i.e., shine through, into the interior 13.

From a combined view with FIG. 2, it can be seen that in the arrangement, the illumination device 10 has light sources 22, which are designed to provide light. For example, the respective light source 22 can be electrically operated so that by supplying the respective light source 22 with electrical energy, the respective light source 22 can provide light or radiate light. A person in the interior 13 can visually perceive the light provided by the light sources 22.

Using one of the light sources 22 as an example, it can be seen from FIG. 1 that the respective light source 22 is arranged at least partially in a corresponding cavity 24 of the pane 16. In the exemplary embodiment shown in FIGS. 1 and 2, the respective light source 22 is completely arranged in the respective, corresponding cavity 24 of the pane 16. For example, the respective light source 22 is a light-emitting diode (LED). It can be seen from FIG. 1 that the respective cavity 24 is a blind hole which does not completely penetrate the laminated glass pane 12, rather only the pane 16. The respective cavity 24 in itself, i.e., considered by itself, is open to the interior 13 and thus at its respective end facing away from the film 18 and the pane 14. Thus, for example, the respective light source 22 can be moved via the open end of the respective, corresponding cavity 24 into the respective, corresponding cavity 24, and thus can be arranged in the respective, corresponding cavity 24. The respective cavity 24 is designed as a through opening, which completely penetrates the pane 16, and thus considered by itself is open both at its respective end facing away from the film 18 and from the pane 14, as well as at its respective end facing towards the film 18 and the pane 14. For example, the respective cavity 24 is designed as a drilled hole, i.e., is formed in the pane 16 by mechanically drilling the pane 16.

In the exemplary embodiment shown in FIGS. 1 and 2, the respective light source 22 is connected to the pane 16 and thus to the laminated glass pane 12 by adhesion. For this, for example, the respective light source 22 is, in particular directly, adhesively bonded to the pane 16. In this case, it is in particular conceivable that the respective light source 22 is glued into the respective, corresponding cavity 24 and is thereby connected to the pane 16. The respective light, which can be or is provided by the respective light source 22, can be supplied, i.e., coupled, into the pane 16 and for example, via the pane 16 into the laminated glass pane 12, in order to subsequently illuminate the interior 13, for example, by means of light provided by the light source 22. An advantageously high illuminance can be realized by an accordingly high number of light sources 22.

It can be seen from FIG. 1 that the pane 16 is arranged on a respective inner side of the film 18 and the pane 14, facing towards the interior 13, so that the pane 16 is an inner pane, i.e., an internal pane. The pane 14 is arranged on a respective outer side of the film 18 and the pane 16, facing away from the interior 13, so that the pane 14 is an outer pane, i.e., an external pane, of the laminated glass pane 12. In particular, the film 18 serves as splinter protection, so that the laminated glass pane 12 is designed as a laminated safety glass (VSG), i.e., as a laminated safety glass pane. The film 18, also referred to as a composite film, is preferably formed from PVB (polyvinyl butyral). In particular, the panes 14 and 16 and the film 18 are connected to each other by lamination. The laminated glass pane 12 is thus a glass roof pane in a laminated construction with lighting, which is realized by the illumination device 10.

The respective cavities 24 themselves lead to weakening of the pane 16, so that the higher the number of light sources 22 and thus the number of corresponding cavities 24, the more the pane 16 is weakened by the cavities 24.

In order to be able to realize a particularly high level of robustness of the pane 16 and thus of the laminated glass pane 12 and in the process in particular keep the breakage sensitivity of the pane 16 and thus of the laminated glass pane 12 particularly low, the pane 16 is provided on its side 26, also referred to as an inner side, facing away from the film 18 and from the pane 14 and facing towards the interior 13, with a coating 28 which completely covers the cavities 24 and the light sources 22 towards the interior 13. In the exemplary embodiment shown in FIGS. 1 and 2, the coating 28 is a coating/material layer, in particular without interruptions and thus continuous, common to the light sources 22 and the cavities 24, by which the light sources 22 and the cavities 24 are in each case completely covered towards the interior 13. In an alternative embodiment, not shown in the figures, it is provided that a respective, single coating, also referred to as an individual coating, is assigned to the respective light source 22 and to the respective, corresponding cavity 24, and the pane 16 is provided with this coating on its inner side, wherein the respective light source 22 and the respective, corresponding cavity 24 is completely covered towards the interior 13 by the respective assigned individual coating. In this case, for example, the individual coatings are not connected to each other, i.e., they are in particular completely spaced apart from each other.

It can be seen from FIG. 1 that the light source 22 is connected to a support element 30, which is also referred to as a light element support. The light source 22 can be supplied via the support element 30 with the aforementioned, electrical energy, by means of which the respective light source 22 can provide the light. In particular, for example, the support element 30 has a line terminal to which, for example, a line designed to conduct the electrical energy can be connected in particular electrically and preferably also mechanically. Therefore, the electrical energy can be supplied from the line to the line terminal and via the line terminal and via the support element 30 of the respective light source 22. In this case, the support element 30 is also covered towards the interior 13, in particular completely, by the coating 28.

The coating 28 directly contacts a first partial region T1 of the inner side of the pane 16, and the coating 28 directly contacts a side S of the support element 30, facing towards the interior 13 and facing away from the film 18 and from the pane 14, so that the partial region T1 and the side S are covered, in particular completely, towards the interior 13 by the coating 28.

The pane 16 is advantageously reinforced by the coating 28 so that the breakage sensitivity of the pane 16 or the laminated glass pane 12 can be kept overall advantageously low. Preferably, the coating 28 is formed from a plastic which can be an ethylene vinyl acetate (EVA). In this case, it is conceivable in particular that the coating 28 can be designed as a further film which is provided in particular in addition to the film 18 and can preferably be formed from the mentioned plastic, in particular from the ethylene vinyl acetate. Alternatively, it would be conceivable for the coating 28 to be formed from a plastic foam, in particular from a polyurethane foam (PU).

It can be seen particularly well from FIGS. 1 and 2 that the pane 16 is provided only locally with the coating 28 on its inner side. This means that the pane 16, in particular the side 26, is provided with the coating 28 in at least or exactly one first region B1, so that the region B1 is covered to the interior 13 by the coating 28, wherein the pane 16, in particular the side 26, has at least or exactly one, second region B2 adjoining, in particular directly, the first region B1, which is free from the coating 28 and thus not covered towards the interior 13 by the coating 28. Therefore, a cost-effective and weight-optimized reinforcement of the laminated glass pane 12 can be realized by the coating 28.

In FIG. 2 a viewing area, also referred to as a glass viewing area, of the laminated glass pane 12 is marked with SB. People located in the interior 13 can visually perceive the viewing area SB and in particular can look through the viewing area SB and thus can look out at the surroundings 20 via the viewing area SB from the interior 13. It can be seen from FIG. 2 that the coating 28 is arranged completely outside the viewing area SB, so that the people located in the interior 13 cannot visually perceive, i.e., cannot see, the coating 28. Therefore, a disadvantageous visual impairment can be avoided. In particular, the first region B1, provided with the coating 28, adjoins the viewing area SB in the vehicle transverse direction and/or in the vehicle longitudinal direction towards the outside, so that, for example, the first region B1, provided with the coating 28, is a surrounding pane section.

1.-9. (canceled)

10. An arrangement of a vehicle, comprising:
an illumination device (10);
a laminated glass pane (12), wherein the illumination device (10) is disposed on the laminated glass pane (12);
wherein the laminated glass pane (12) has a first pane (14), a second pane (16), and a film (18) disposed between the first pane (14) and the second pane (16);
wherein the illumination device (10) has a light source (22) that is disposed at least partially in a cavity (24) of the second pane (16); and
a support element (30), wherein the light source (22) is connected to the support element (30) and wherein the light source (22) is supplyable with electrical energy via the support element (30);
wherein the second pane (16) has a coating (28) that covers the cavity (24), the light source (22), and the support element (30) on a first side (26) of the second pane (16) that faces away from the first pane (14) and from the film (18) and that faces towards an interior of the vehicle.

11. The arrangement according to claim 10, wherein the coating (28) is a plastic.

12. The arrangement according to claim 11, wherein the plastic is ethylene vinyl acetate.

13. The arrangement according to claim 10, wherein the coating (28) is a plastic foam.

14. The arrangement according to claim 10, wherein the cavity (24) is a blind hole.

15. The arrangement according to claim 10, wherein the light source (22) is connected to the second pane (16) by an adhesive.

16. A vehicle, comprising:
the arrangement according to claim 10.

17. The vehicle according to claim 16, wherein the coating (28) is disposed outside a viewing area (SB) of the laminated glass pane (12).

18. A laminated glass pane (12) for a vehicle, comprising:
a first pane (14), a second pane (16), and a film (18) disposed between the first pane (14) and the second pane (16);
an illumination device (10), wherein the illumination device (10) has a light source (22) that is disposed at least partially in a cavity (24) of the second pane (16); and
a support element (30), wherein the light source (22) is connected to the support element (30) and wherein the light source (22) is supplyable with electrical energy via the support element (30);
wherein the second pane (16) has a coating (28) that covers the cavity (24), the light source (22), and the support element (30) on a first side (26) of the second pane (16) that faces away from the first pane and from the film (18).
